(19) United States
(12) Patent Application Publication
(10) Pub. No.: US 2011/0286205 A1
(43) Pub. Date: Nov. 24, 2011

(54) Apparatus For Portable Wireless Light Display System

(76) Inventors: Richard Redpath, Cary, NC (US); Sarah Donan Redpath, Cary, NC (US)

(21) Appl. No.: 12/785,457

(22) Filed: May 23, 2010

(51) Int. Cl. F21L 4/00

(52) U.S. Cl. 362/157

(57) ABSTRACT

The present invention relates to a portable wireless light display system for holiday displays and parties. The system provides a unique battery operated portable device that can be placed in a window to provide holiday or festive lighting on objects without the use of the traditional wired light bulb implementation.

### BACKGROUND OF INVENTION

The present invention relates to a portable wireless light display system for holiday displays and more specifically a safe battery operated system to simulate the traditional hung wire and light bulb lighting in a wireless manner.

Other prior art consists of large bulky plug-in wired power display units such as laser stage lighting FU-MINI01 by Fuzhe Technology Co Ltd. These units utilize class IIIb lasers and are intended for projections that are well away of imposing dangerous eye contact. Stage lighting is a common form to provide entertainment lighting and lasers are used to make the lighting sharper.

Alternatively Firefly Lights by Firefly Magic® provides a patented computer controlled wired device for landscape usage for points of light to be displayed. While Firefly lighting provides a compelling point light utility the use of wires poses a problem for repositioning, timely setup, and removal.

Additionally there are available laser pointers with attached matrix diffractions elements to produce dot projections. These systems are unrealistic as to provide a holiday lighting system and are more a novelty than a utility since they require a human to project and are intended for limited time use for laser life and battery use.

Alternatively there is the Laserpod™ product which provides a battery operated galaxy show from LEDs in combination with a laser of which this product requires a considerable dark room ceiling or wall for the effect of this specialized lighting for a slurry of light output. The lighting is not focused enough to produce traditional holiday wired light bulb lighting and not possible when mixing LEDs and lasers as LEDs will wash out coherent light effects for point lighting. Traditional wired bulb/LED holiday lighting is tedious to setup and more tedious to remove as well as not easy to reposition once setup. There is a need to resolve this problem to provide quick setup, easy repositioning, and unburdened removal.

In this respect, the Apparatus For Portable Wireless Light Display System substantially departs from the conventional design of the modern day purchasable system prior arts and in doing so provides a portable wireless battery operated display system for festive occasions, holiday lights and landscape lighting. More specifically, the present invention can provide the effect of individual holiday bulb lighting (indoor and outdoor) without the need for wires as well as Firefly points of light landscape lighting. In addition, the embodiment provides a means above traditional indoor holiday wired lighting that is not possible such as point lighting the three dimensional space of kitchen work areas that would normally be conflicted by the use of electrical wiring for safety.

### BRIEF SUMMARY OF INVENTION

The invention relates to a battery operated portable wireless light display system for landscape illumination, festive occasion lighting and holiday lights. In view of the prior art, the present invention provides a unique portable aspect to create holiday lights for three dimensional projection effect with safe eye operation without the use of wires that can closely match the traditional holiday lighting technique today that uses wires and light bulbs or wires and LEDs

### BRIEF DESCRIPTION OF DRAWINGS

FIG. 1 is diagram of the embodiment operation.

FIG. 2 is a circuit diagram for an implementation.

FIG. 3 is the embodiment shown lighting of unsafe wired lighting areas safely.

### DETAIL DESCRIPTION OF THE INVENTION

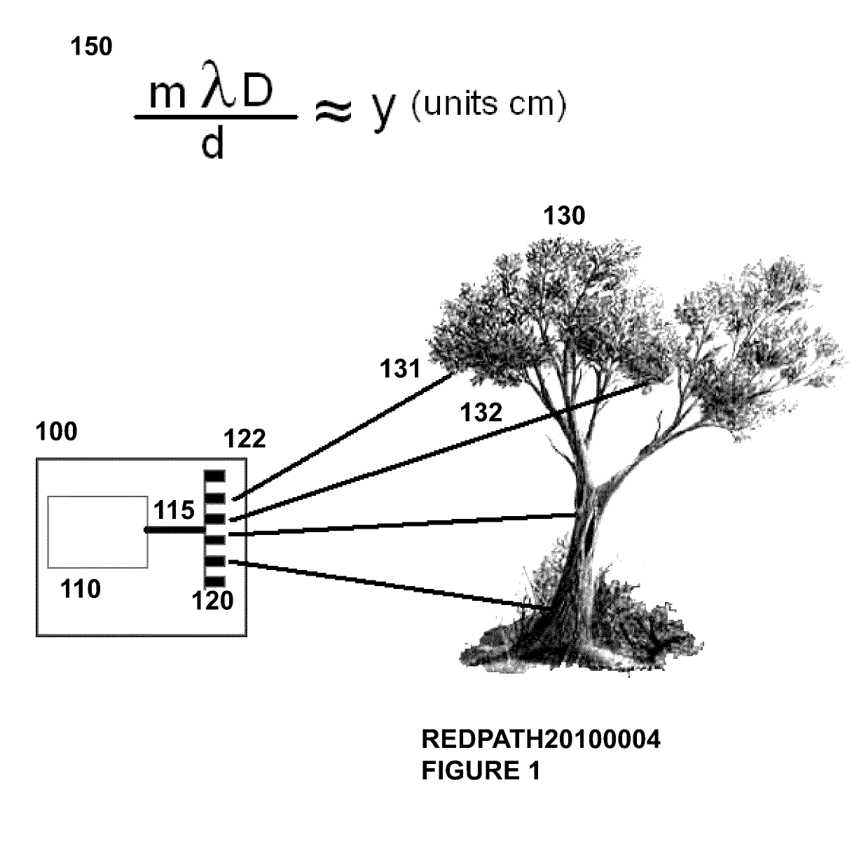

Referring to FIG. 1 at 100 is the embodiment. At 110 is a laser for coherent light which is required to achieve the sharp focused points of light for the embodiment. At 120 is a matrix diffraction grating typically 50 lines per millimeter in which the laser beam at 115 from laser at 110 is incident for transmission at 122. The incident of the laser beam at 115 to the diffraction grating at 120 will result in a transmission output at 122 well within safe eye operation. The diffraction grating transmission at 122 will incident with three dimensional objects such as a tree at 130 to create example points at 131 and 132. The points at 131 and 132 are in three dimensional space for viewing and have the simulating effect of hung wire and bulb lights.

An optimal diffraction grating at 120 for the embodiment to produce the effect of holiday lighting can be calculated with the formula at 150. The displacement y is equal to the order m times the wavelength Lambda times the distance D divided by the slit separation d. The displacement from the center line for orders of m can be computed for optimal holiday lighting displacement. One skilled in the area of diffraction grating products can accurately compute the best diffraction grating but for completeness a 50 lines/mm diffraction grating is recommended. A 50 lines per millimeter diffraction grating has a slit separation of 20 micrometers 2.0E-5 meters. Lamba is a green laser at 542 nm, D is a projection of 300 cm for an application such as a kitchen. Referring to FIG. 1 at 150 the formula result for a 50 lines/mm diffraction grating for first order m=1 computes a distance separation of approximately 8.13 cm. If the laser is red at 650 nm the displacement is 9.75 cm. This separation is optimal for a typical kitchen space and outdoor lighting to achieve the traditional wired holiday lighting.

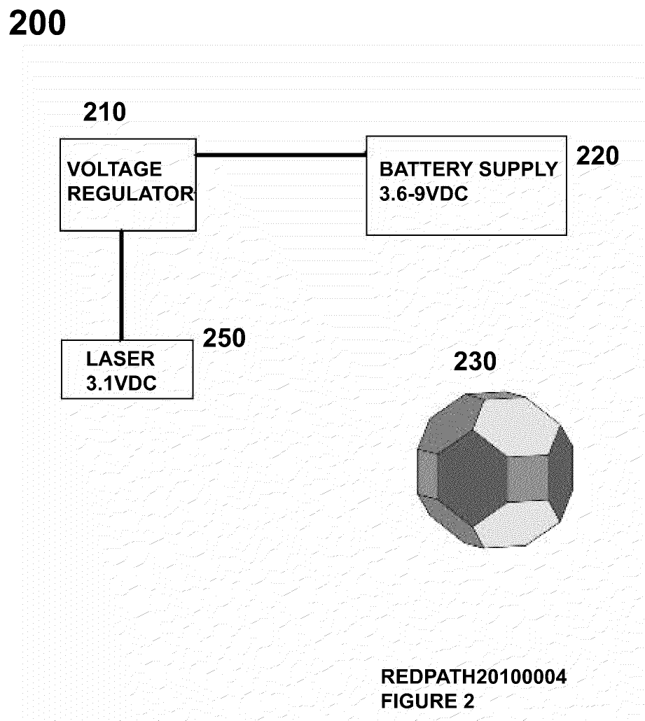

Referring to FIG. 2 at 200 is a diagram of the embodiment circuit implementation. At 210 is a voltage regulator for laser power source at 250. At 210 the voltage regulator is connected to battery supply at 220. One skilled in the area of circuit design can provide this implementation and it is shown here for completeness. At 250, specifically a laser diode module is used with heat sink as to provide a small compact implementation with batteries. More specifically at 230 is an enclosure shown which occupies a square volume of 9 cm by 9 cm by 9 cm for the embodiment to be portable and positionable.

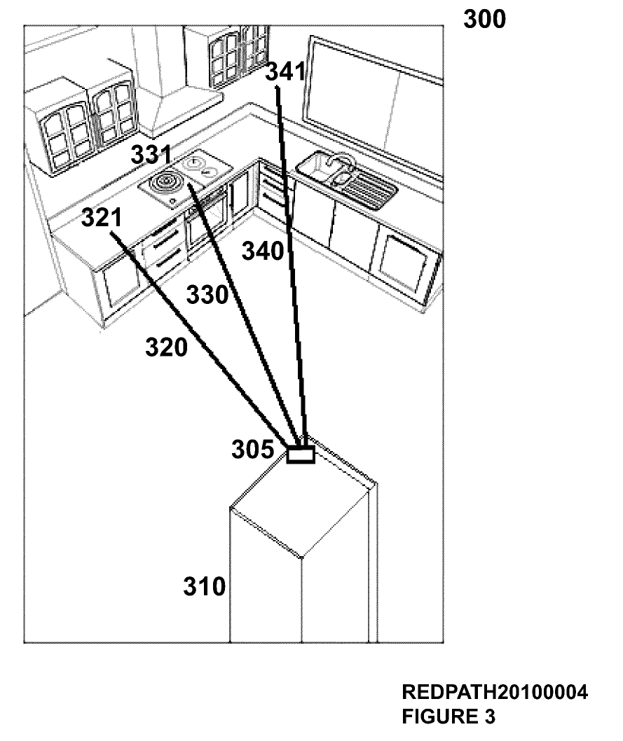

Referring to FIG. 3 at 300 is a one point perspective diagram of a kitchen. At 305 is the embodiment referenced in FIG. 1 at 100 on top of refrigerator at 310. Referring to FIG. 3 the embodiment at 305 are diagrammed laser beam path diffractions at 320, 330, and 340 from the embodiment diffraction shown in FIG. 1 at 120 for output. Referring to FIG. 3 at 320 is diagrammed a laser beam path incidence with kitchen counter at 321. This incidence at 321 appears to be a traditional light bulb or LED. The use of a traditional wire and bulb utility would be unrealistic for kitchen use at 321. At 330 is another diagrammed laser beam path which is incidence to kitchen stove at 331. This incidence at 331 appears to be a traditional light bulb or LED. Again the use of a traditional wire and bulb utility would be unrealistic and unsafe for kitchen use at 331. At 340 is another diagrammed laser beam path which is incidence to the kitchen wall at 341 seemingly to appear floating in space as a traditional light bulb or LED with no wires of its source.

What is claimed is:

1. Apparatus For Portable Wireless Light Display System using battery operation for a laser beam diffraction grating to produce light projections that simulates a traditional wire and light bulb holiday display.

2. Apparatus For Portable Wireless Light Display System in claim 1 for temporary indoor lighting for holidays to achieve a hybrid of dimensional space lighting in use areas that would be unsafe for traditional wired lighting.

3. Apparatus For Portable Wireless Light Display System in claim 1 for practical moveable landscape lighting for holidays.
